(19) United States
(12) Patent Application Publication
(10) Pub. No.: US 2016/0062183 A1
(43) Pub. Date: Mar. 3, 2016

(54) DISPLAY APPARATUS

(71) Applicant: SAMSUNG ELECTRONICS CO., LTD., Suwon-si (KR)

(72) Inventors: Jun-ho SUNG, Seoul (KR); Il-yong JUNG, Yongin-si (KR); Seong-eun CHUNG, Namyangju-si (KR)

(73) Assignee: SAMSUNG ELECTRONICS CO., LTD., Suwon-si (KR)

(21) Appl. No.: 14/827,416

(22) Filed: Aug. 17, 2015

(30) Foreign Application Priority Data
Sep. 3, 2014 (KR) 10-2014-0117098

(51) Int. Cl. G02F 1/1335

(52) U.S. Cl. CPC G02F 1/133603; G02F 1/133528; G02F 1/133514; G02F 2001/133614

(57) ABSTRACT

A display apparatus is provided. The display apparatus includes: a light source; and a display panel including: an upper substrate and a lower substrate; a liquid crystal layer interposed in between the upper substrate and the lower substrate; a lower polarization layer interposed in between the lower substrate and the liquid crystal layer; a upper polarization layer interposed in between the liquid crystal layer and the upper substrate; and a color conversion layer arranged in either a first position between the upper substrate and the upper polarization layer or a second position between the lower substrate and the lower polarization layer, and configured to receive light from the light source and emit light corresponding to a plurality of colors by converting a part of the light corresponding to a first color into light corresponding to respective colors other than the first color among the plurality of colors.

### CROSS-REFERENCE TO RELATED APPLICATION

This application claims priority from Korean Patent Application No. 10-2014-0117098, filed on Sep. 3, 2014 in the Korean Intellectual Property Office, the disclosure of which is incorporated herein by reference.

### BACKGROUND

1. Field

Apparatuses and methods consistent with the exemplary embodiments relate to a display apparatus for displaying an image, and more particularly to a display apparatus having an improved structure for minimizing an optical loss caused while light emitted from a backlight unit undergoes color filtering in a display panel.

2. Description of the Related Art

A display apparatus refers to an apparatus provided with a display panel for displaying an image generated from a broadcasting signal or from image signal/image data in various formats. The display apparatus may be a television (TV), a monitor, portable device etc. Further, a display panel may be implemented using various types of technologies such as a liquid crystal display (LCD) panel, a plasma display panel (PDP), etc. that may be applied to various display apparatuses.

The display panel provided in the display apparatus may be classified into a light-receiving panel structure and a self-emissive panel structure in accordance with light generation methods. In the light-receiving panel structure, the panel does not emit light by itself, and therefore a backlight unit is separately needed to emit light to the panel. For example, the LCD panel has a light-receiving panel structure. On the other hand, in the self-emissive panel structure, the panel emits light by itself and therefore there is no need of a separate backlight unit. For example, an organic light emitting diode (OLED) has a self-emissive panel structure.

The display panel of the light-receiving panel structure has to apply color filtering to light emitted from the backlight unit so as to display a color image. For example, the display panel includes a color filter layer for filtering red, green and blue light corresponding to sub pixels from white light emitted from the backlight unit. However, an optical loss occurs while the light is filtered by the color filter layer. Accordingly, the color filter layer is required to have a structure for minimizing the optical loss.

### SUMMARY

According to an exemplary embodiment, there is provided a display apparatus including: a light source configured to emit light corresponding to a first color among a plurality of preset colors; and a display panel configured to display a color image with the light emitted from the light source, the display panel including: an upper substrate and a lower substrate; a liquid crystal layer interposed in between the upper substrate and the lower substrate; a lower polarization layer interposed in between the lower substrate and the liquid crystal layer, and configured to polarize the emitted light; a upper polarization layer interposed in between the liquid crystal layer and the upper substrate, and configured to polarize the emitted light passed through the liquid crystal layer; and a color conversion layer arranged in either a first position between the upper substrate and the upper polarization layer or a second position between the lower substrate and the lower polarization layer, and configured to emit light corresponding to the plurality of colors by converting a part of the light corresponding to the first color into light corresponding to respective colors other than the first color among the plurality of colors. Thus, the light corresponding to the first color, not converted in the emitted light, exits together with light corresponding to the colors other than the first color, thereby finally emitting the light corresponding to the plurality of colors and displaying a color image on the display image. Further, since the light emitted from the light source is converted to have colors, an optical loss due to the related art color filtering method can be minimized.

The plurality of colors may include red, green and blue (RGB) colors, and the first color may include a blue color, and the colors other than the first color may include red and green colors. The light source for emitting the blue light is directly used, so that an optical efficiency can be improved with regard to applied voltage and the emitted light can be easily converted into light corresponding to the RGB colors.

The display panel may include sub pixels per pixel respectively corresponding to the RGB colors, and the color conversion layer may include: a red conversion layer configured to correspond to a red sub pixel and including a material of which particles collide with blue light to generate red light; and a green conversion layer configured to correspond to a green sub pixel and including a material of which particles collide with blue light to generate green light. Thus, it is possible to convert the blue light into the red and green light.

Each material of the red conversion layer and the green conversion layer may include a phosphor or a quantum dot material. Thus, the color of the light can be converted with the minimum optical loss as compared with the related art color filtering method using the dyes.

The color conversion layer may further include a transmission layer corresponding to a blue sub pixel and including a transparent material which directly transmits blue light. Thus, a part of the blue light in the emitted light can be maintained and output without change.

The display apparatus may further including a blue light filter layer arranged at light-exiting sides of the red conversion layer and the green conversion layer, and configured to block the blue light. Thus, the blue light that may exit from the red conversion layer and the green conversion layer is blocked, thereby securing the quality of a color image.

The plurality of colors may include a white (W) color in addition to the RGB colors, and the colors other than the first color may include red, green and white colors. The present exemplary embodiments may be applied to not only the display panel having the structure of the RGB sub pixels but also the display panel having the structure of the RGBW sub pixels.

The sub pixels may respectively correspond to the RGBW colors, and the color conversion layer may further include a white conversion layer configured to correspond to a white sub pixel and including a material of which particles collide with blue light to generate white light.

The color conversion layer may include a blue light filter layer arranged at light-exiting sides of the red conversion layer, the green conversion layer and the white conversion layer, and configured to block the blue light.

At least one of the lower polarization layer and the upper polarization layer may include a linear grid structure provided for polarizing light in a preset polarization direction. In the linear grid structure where the polarization layer is formed inside the display panel, the color conversion layer can be installed outside the structure of the polarization layers. If the color conversion layer is arranged between the polarization layers, the polarization properties of the light characterized by the lower polarization layer are affected by the color conversion layer. Therefore, the color conversion layer is arranged outside the structure of the polarization layers so that the polarization properties of the light can be free from the color conversion layer.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is an exploded perspective view of a display apparatus according to an exemplary embodiment;

FIG. 2 is a cross-section view showing that elements of a display panel are laminated in the display apparatus of FIG. 1;

FIG. 3 is a perspective view partially showing a lower polarization layer in the display panel of FIG. 2;

FIG. 4 is a lateral cross-section view showing a laminated structure of the lower polarization layer of FIG. 3;

FIG. 5 shows a principle that a color filter layer in the display panel of FIG. 2 filters red, green and blue (RGB) light from light of a light source;

FIGS. 6 and 7 are cross-section views showing that elements of a display panel are laminated according to an exemplary embodiment;

FIG. 8 shows an exemplary principle that a color conversion layer of FIG. 6 filters RGB light from light of a light source;

FIG. 9 shows a principle that a color conversion layer according to an exemplary embodiment filters RGB light from light of a light source;

FIG. 10 shows a principle that a color conversion layer according to an exemplary embodiment filters RGBW light from light of a light source; and

FIG. 11 is a block diagram of a display apparatus according to an exemplary embodiment.

### DETAILED DESCRIPTION OF EXEMPLARY EMBODIMENTS

Below, exemplary embodiments will be described in detail with reference to accompanying drawings. In the following exemplary embodiments, only elements directly related to the exemplary embodiment will be described, and descriptions about the other elements will be omitted. However, it will be appreciated that the elements, the descriptions of which are omitted, are not unnecessary to understand the apparatus or system according to the exemplary embodiments.

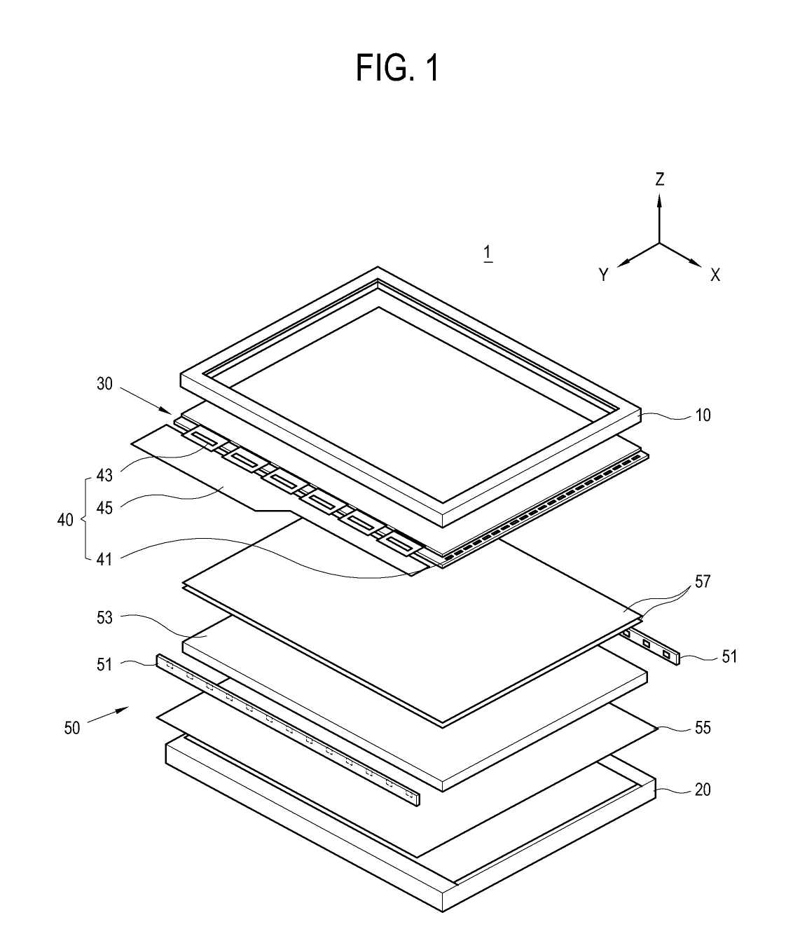

FIG. 1 is an exploded perspective view of a display apparatus 1 according to an exemplary embodiment. In this exemplary embodiment, the display apparatus 1 including a display panel 30 employing a liquid crystal will be described.

As shown in FIG. 1, the display apparatus 1 refers to an apparatus that processes an image signal received from the exterior and displays an image based on the image signal. In this exemplary embodiment, a television (TV) will be described as an example of the display apparatus 1. However, the display apparatus 1 may be implemented as a TV, a monitor, a portable multimedia player, a mobile phone, etc. Accordingly, there is no limit to the display apparatus 1 as long as it includes the display panel 30 capable of displaying an image.

The display apparatus 1 includes cover frames 10 and 20 forming an accommodating space therein, a display panel 30 accommodated in the accommodating space between the cover frames 10 and 20 and displaying an image on an top surface, a panel driver 40 driving the display panel 30, and a backlight unit 50 arranged to face a bottom surface of the display panel 30 within the accommodating space between the cover frames 10 and 20 and emitting light to the display panel 30.

The directions shown in FIG. 1 are as follows. In the drawings, the X, Y and Z directions respectively indicate horizontal, vertical and normal directions of the display panel 30. In this drawing, the display panel 30 is arranged in parallel with an X-Y plane formed by an X-directional axis and a Y-directional axis, and the cover frames 10 and 20, the display panel 30 and the backlight unit 50 are arranged and laminated along a Z-directional axis. In addition, opposite directions to the X, Y and Z directions will be represented as −X, −Y and −Z directions, respectively.

Further, unless stated otherwise, “top/above” means the Z direction, and “bottom/below” means the −Z direction. For example, the backlight unit 50 is placed below the display panel 30, and light emitted from the backlight unit 50 enters a bottom surface of the display panel 30 and exits from a top surface of the display panel 30.

The cover frames 10 and 20 form an outer appearance of the display apparatus 1, and support the display panel 30 and the backlight unit 50 accommodated therein. With respect to the display panel 30 shown in the drawing, if the Z direction is the upward or frontward direction and the −Z direction is the downward or backward direction, the cover frames 10 and 20 includes a front cover 10 supporting the front side of the display panel 30, and a rear cover 20 supporting the back of the backlight unit 50. The front cover 10 includes an opening through which an image display area of the display panel 30 is exposed to the outside, on a plane parallel with the X-Y plane.

The display panel 30 employs a liquid crystal (not shown), which is filled in between two substrates (not shown), and displays an image thereon as the liquid crystal is varied in orientation depending on a driving signal. The display panel 30 is not able to emit light by itself, and receives light from the backlight unit 50 so that an image can be displayed on the image display area thereof.

The panel driver 40 transmits a driving signal for driving a liquid crystal layer (not shown) to the display panel 30. The panel driver 40 includes a gate driving integrated circuit (IC) 41, a data chip film package 43, and a printed circuit board 45.

The gate driving IC 41 is integrated and installed on the substrate (not shown) of the display panel 30, and respective gate lines (not shown) of the display panel 30. The data chip film package 43 is connected to respective data lines (not shown) of the display panel 30. The data chip film package 43 may include a wiring pattern that a semiconductor chip is formed on a base film, and a tape automated bonding (TAB) tape adhered by TAB technology. As an example of the chip film package, a tape carrier package (TCP), a chip on film (COF) or the like may be used. The printed circuit board 45 inputs a gate driving signal to the gate driving IC 41, and a data driving signal to the data chip film package 43.

With this configuration, the panel driver 40 inputs the driving signals to each gate line (not shown) and each data line (not shown) of the display panel 30, thereby driving the liquid crystal layer (not shown) of the display panel 30 in units of pixels.

The backlight unit 50 is arranged in the −Z direction of the display panel 30 so as to emit light to the bottom surface of the display panel 30. The backlight unit 50 includes a light source 51 arranged at an edge of the display panel 30, a light guiding plate 53 arranged in parallel with the display panel 30 to face the bottom surface of the display panel 30, a reflective plate 55 arranged placed below of the light guiding plate 53 and facing the bottom surface of the light guiding plate 53, and one or more optical sheets 57 interposed between the display panel 30 and the light guiding plate 53.

According to an exemplary embodiment, the backlight unit 50 has an edge-type structure where the light source 51 is arranged at the edge of the light guiding plate 33, and a light emitting direction of the light source 51 is perpendicular to a light exiting direction of the light guiding plate 53. However, the backlight unit 50 is not limited to this exemplary embodiment, and may be designed in an alternative manner. Alternatively, the backlight unit 50 may have a direct-type structure where the light source 51 is arranged below of the light guiding plate 53, and the light emitting direction of the light source 51 is parallel to the light exiting direction of the light guiding plate 53.

The light source 51 emits light, and the emitted light enters the light guiding plate 53. The light source 51 is installed standing on the surface of the display panel 30, i.e. the X-Y plane. The light source 51 may be arranged along at least one among four edges of the display panel 30 or the light guiding plate 53. The light source 51 may be achieved by sequentially arranging a light emitting device (not shown) such as a light emitting diode (LED), etc. on a module substrate (not shown) extended along the X direction.

The light guiding plate 53 is a plastic lens achieved by an acrylic mold, etc. and uniformly guides incident light from the light source 51 to the entire image display area of the display panel 30. The bottom surface of the light guiding plate 53 in the −Z direction faces the reflective plate 55. Further, lateral walls in the Y and −Y directions of the light guiding plate 53 among four directional lateral walls formed in between the upper and bottom surfaces face the light source 51. Thus, the light emitted from the light source 51 enters the lateral walls in the Y and −Y directions of the light guiding plate 53.

In addition, various optical patterns (not shown) for scattering light propagating within the light guiding plate 53 or changing the traveling direction of the light are formed on the bottom surface of the light guiding plate 53, so that the light exiting from the light guiding plate 53 can uniformly distributed.

The reflective plate 55 is placed below of the light guiding plate 53, and reflects the light exiting outward from the inside of the light guiding plate 53 to the light guiding plate 53 again. The reflective plate 55 also returns the light not reflected from the optical patterns formed on the bottom surface of the light guiding plate 53 to the light guiding plate 53. To this end, the top surface of the reflective plate 55 has a property of total reflection.

One or more optical sheets 57 are laminated above the light guiding plate 53 and adjust optical properties of the light exiting from the light guiding plate 53. The optical sheet 57 may include various sheets for controlling optical properties, for example, a diffusion sheet, a prism sheet, a protective sheet, etc. as necessary. In consideration of the finally adjusted optical properties, two or more sheets may be combined and laminated.

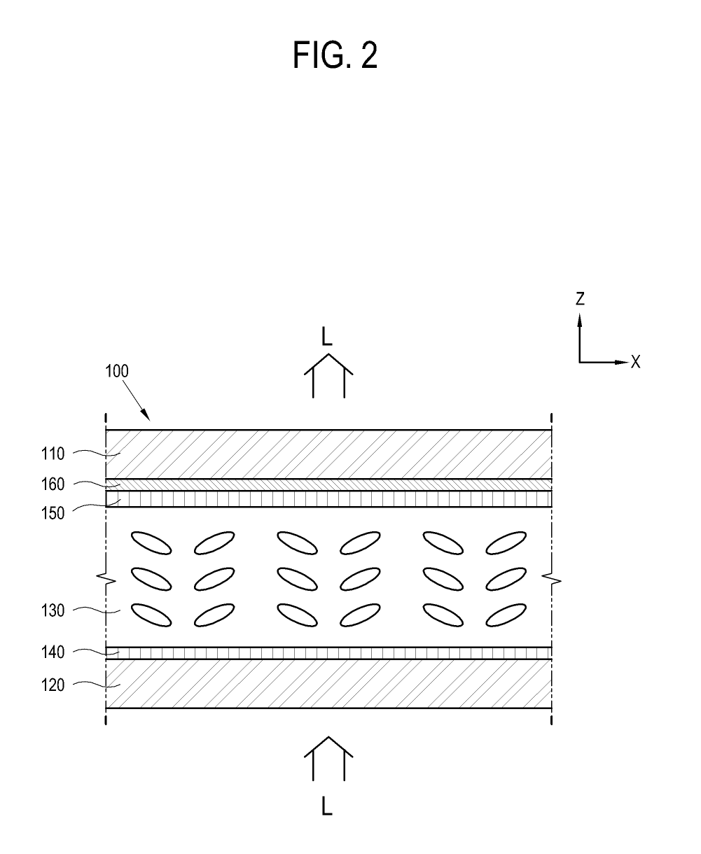

FIG. 2 is a cross-section view showing that elements of the display panel 100 are laminated in the display apparatus of FIG. 1. The display panel 100 of FIG. 2 is substantially the same as the display panel 30 of FIG. 1, and thus applicable to the display apparatus 1 of FIG. 1.

As shown in FIG. 2, the light L emitted from the backlight unit 50 (refer to FIG. 1) in the Z direction enters the display panel 100, and exits from the Z direction via many elements of the display panel 100. In the following description, the ‘top/above’ and ‘bottom/below’ represent a relative arranging or laminating relationship along the traveling direction of the emitted light L, i.e. the Z direction.

The display panel 100 includes an upper substrate 110, a lower substrate 120 arranged to face the upper substrate 110, a liquid crystal layer 130 filled in between the upper substrate 110 and the lower substrate 120, a lower polarization layer 140 interposed in between the liquid crystal layer 130 and the lower substrate 120, an upper polarization layer 150 interposed in between the liquid crystal layer 130 and the upper substrate 110, and a color filter layer 160 interposed in between the upper substrate 110 and the upper polarization layer 150. The foregoing display panel 100 is one of various panel structures, and may vary in a panel structure depending on design methods. Thus, the present exemplary embodiment does not limit the structure of the display panel 100.

Below, elements of the display panel 100 will be described in detail.

The upper substrate 110 and the lower substrate 120 are transparent substrates arranged to face each other leaving a predetermined distance therebetween along the traveling direction of the light. In light of materials, the upper substrate 110 and the lower substrate 120 are achieved by glass or plastic substrates. If a plastic substrate is used, the upper substrate 110 and the lower substrate 120 may be made of polycarbonate (PC), polyimide (PI), polyethersulphone (PES), polyacrylate (PAR), polyethylenenaphthelate (PEN), poly-ethylene-terephehalate (PET), or etc.

The upper substrate 110 and the lower substrate 120 may be required to have preset properties in accordance with driving methods of the liquid crystal layer 130. For example, soda lime glass may be used if the liquid crystal layer 130 is driven by a passive matrix method, and alkali free glass and borosilicate glass may be used if the liquid crystal layer 130 is driven by an active matrix method.

The liquid crystal layer 130 is interposed between the upper substrate 110 and the lower substrate 120, and varied in orientation of a liquid crystal depending on the driving signals, thereby controlling light transmission. General liquid has no regularity in orientation and arrangement of molecules, but liquid crystal has regularity to some extent as a liquid phase. As an example, there is a solid that shows double refraction or the like anisotropy when it is melted by heating. The liquid crystal has double refraction, color change or the like optical properties. This material has the regularity like crystal and the liquid phase like liquid and is thus called the liquid crystal since it has both properties of liquid and crystal. The liquid crystal optical properties change since its molecular arrangement varies in orientation depending on applied voltage.

The liquid crystal of the liquid crystal layer 130 may be classified into a nematic, cholesteric, smectice and ferroelectric liquid crystals in accordance with molecular arrangement of the liquid crystal.

The lower polarization layer 140 is formed on the lower substrate 120 in the Z direction, i.e. on the surface of the lower substrate 120 from which the light L exits. The lower polarization layer 140 transmits only components in a first polarization direction of the emitted light L, and reflects remaining components other than the light in the first polarization direction.

The upper polarization layer 150 is formed on the upper substrate 110 in the −Z direction, i.e. on the surface of the upper substrate 110 to which the light L is incident. The upper polarization layer 150 transmits only components in a preset second polarization direction of the emitted light L passing through the lower substrate 120, the lower polarization layer 140 and the liquid crystal layer 130, and reflects remaining components other than the light in the second polarization direction.

The second polarization direction is different from the first polarization direction, and more particularly perpendicular to the first polarization direction. This is because the polarization direction of the emitted light L is rotated by 90 degrees as the emitted light L passes through the liquid crystal layer 130. If the upper polarization layer 150 transmits the same components of the light in the first polarization direction as those of the lower polarization layer 140, the components in the first polarization direction of the light passing through the lower polarization layer 140 cannot pass the upper polarization layer 150 since it is polarized to have the second polarization direction while passing though the liquid crystal layer 130. Therefore, the polarization direction of the light to be passed through the upper polarization layer 150 is perpendicular to the polarization direction of the light to be passed through the lower polarization layer 140.

The upper polarization layer 150 and the lower polarization layer 140 are achieved by linear grids (not shown) shaped like a plurality of bars extended in one direction parallel to the X-Y plane on the upper substrate 110 and the lower substrate 120. The respective bars (not shown) that constitute the linear grid (not shown) are arranged to have pitches at preset intervals and extended in a direction corresponding to each polarization direction. In addition, the linear grid (not shown) of the upper polarization layer 150 protrudes from the upper substrate 110 toward the liquid crystal layer 130, and the linear grid (not shown) of the lower polarization layer 140 protrude from the lower substrate 120 toward the liquid crystal layer 130.

The color filter layer 160 applies color filtering to the emitted light L in units of pixels and outputs colored light. Each pixel of the display panel 100 includes three sub pixels respectively corresponding to red, green and blue (RGB) colors, and the color filter layer 160 includes RGB dye layers corresponding to the respective sub pixels, thereby outputting light with a color corresponding to each sub pixel. The emitted light L passes through the respective RGB dye layers of the color filter layer 160 and thus is filtered to have light of RGB colors.

In this exemplary embodiment, the color filter layer 160 is interposed in between the upper substrate 110 and the upper polarization layer 150, but not limited thereto. Alternatively, the color filter layer may be interposed in between the lower substrate 120 and the lower polarization layer 140.

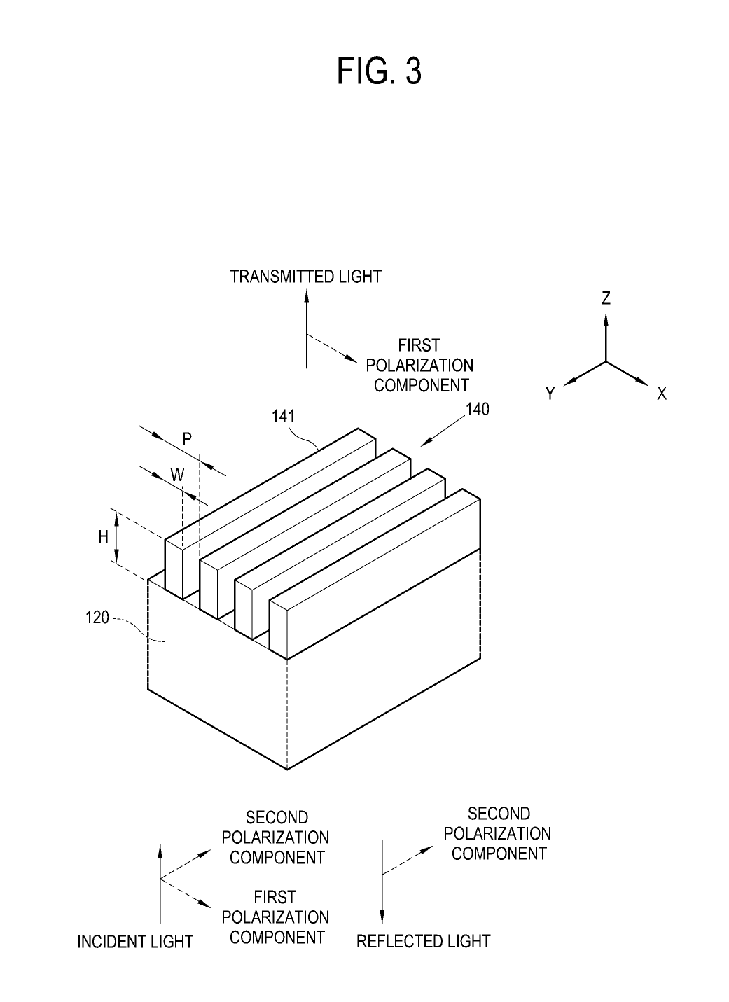

Below, a structure for the lower polarization layer 140 will be described with reference to FIG. 3. The structure for the lower polarization layer 140 may also be applied to that for the upper polarization layer 150.

FIG. 3 is a perspective view partially showing a lower polarization layer in the display panel of FIG. 2.

As shown in FIG. 3, the lower polarization layer 140 has a linear grid (or wire grid) structure where a plurality of bars 141 protruding in the Z direction and extended along the Y direction are arranged in parallel on the lower substrate 120. One bar 141 has a preset height H and a preset width W, and the plurality of bars 141 are periodically arranged with a preset pitch P.

If such a pitch P of the linear grid structure is adjusted into half a wavelength of light, only transmitted light and reflected light are presented without diffracted light. A slit is formed in between two adjacent bars 141 within the linear grid, and the first polarized component in the first polarization direction perpendicular to the extended direction of the bars 141 passes through the lower polarization layer 140 while incident light passes through the slit. On the other hand, the second polarized component in the second polarization direction parallel to the extended direction of the bars 141 does not pass through the lower polarization layer 140 and is thus reflected in the −Z direction. That is, with this linear grid structure, the light passing through the lower polarization layer 140 is polarized in the first polarization direction.

The light reflected without passing through the lower polarization layer 140 is reflected together with the emitted light of the light source 51 (see FIG. 1) from the reflective plate 55 (see FIG. 1) toward the display panel 100. That is, the whole optical efficiency of the light passing through the display panel 100 can be improved without using a related art dual brightness enhancement film (DBEF) since the light filtered without passing through the lower polarization layer 140 can be reused.

To improve the polarization filtering performance of the lower polarization layer 140, a ratio of the width W to the height H of the bar 141, i.e. an aspect ratio may be equal to or higher than 1:3.

The upper polarization layer 150 has a linear grid structure similar to that of the foregoing lower polarization layer 140. However, the linear grid (not shown) of the upper polarization layer 150 is extended in a direction perpendicular to the linear grid 141 of the lower polarization layer 140. For example, if the linear grid 141 of the lower polarization layer 140 is extended along the Y direction, the linear grid (not shown) of the upper polarization layer 150 is extended along the X direction perpendicular to the Y direction. Thus, the upper polarization layer 150 transmits only the second polarized component and does not transmit the first polarized component.

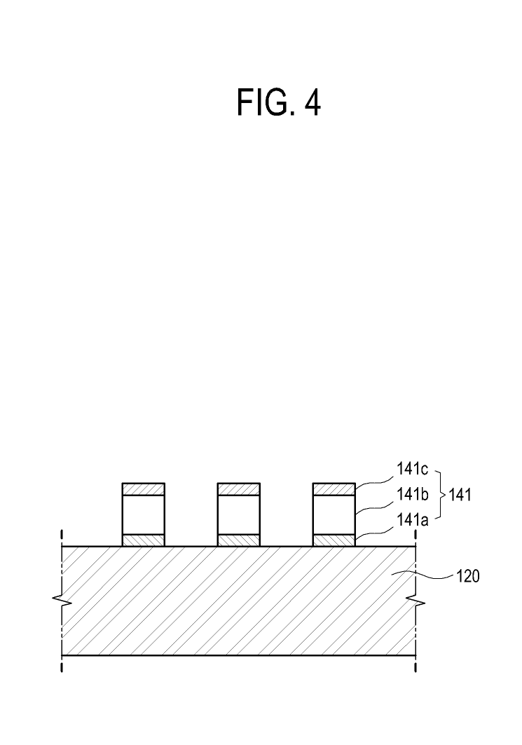

FIG. 4 is a lateral cross-section view showing a laminated structure of the lower polarization layer 140.

As shown in FIG. 4, one bar 141 of the lower polarization layer 140 includes a first dielectric layer 141a, a reflective layer 141b and a second dielectric layer 141c which are sequentially laminated on the lower substrate 120. In light of materials, the first dielectric layer 141a may include silicon nitride (SiNx), the reflective layer 141b may include metal or poly silicon, and the second dielectric layer 141c may include silicon dioxide (SiO2), etc. Of course, there is no limit to such materials, and various materials may be applied to each layer.

Further, in this exemplary embodiment, one bar 141 has the structure of three layers, but not limited thereto. Alternatively, one bar may include a single-layer structure of only the reflective layer, or a double-layer structure of the reflective layer and one dielectric layer.

As described above, the linear grid structure includes a plurality of bars extended in parallel with one another on the glass substrate.

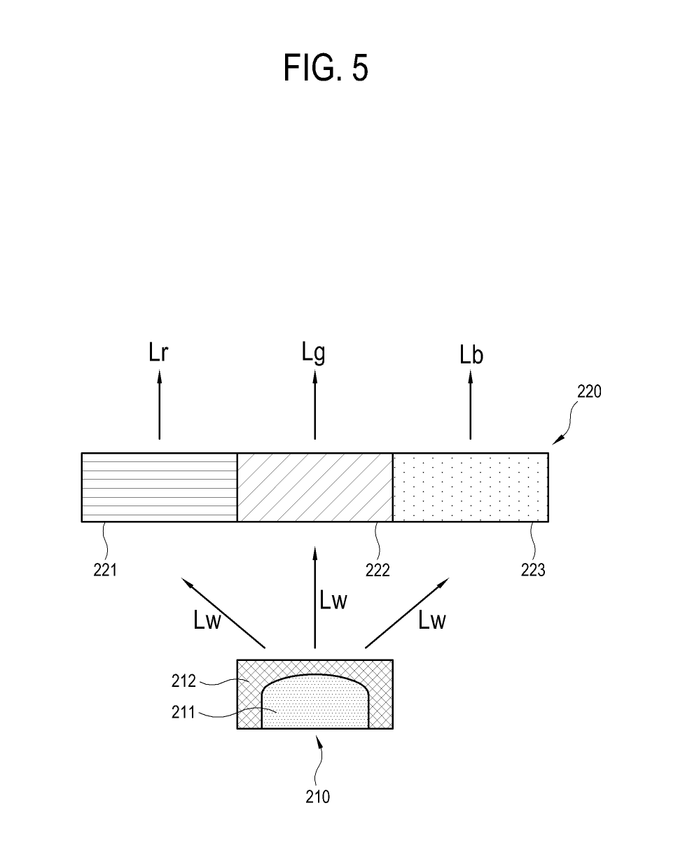

Below, a principle that the color filter layer 160 according to an exemplary embodiment applies color filtering to the light emitted from the light source 51 (see FIG. 1) will be described with reference to FIG. 5.

FIG. 5 shows a principle that the color filter layer 220 in the display panel of FIG. 2 filters red, green and blue (RGB) light from light Lw of a light source 210.

As shown in FIG. 5, white light Lw generated and emitted from the light source 210 is incident to the color filter layer 220, and filtered by a red dye layer 221, a green dye layer 222 and a blue dye layer 223 of the color filter layer 220 into red light Lr, green light Lg and blue light Lb. In this exemplary embodiment, the light source 210 and the color filter layer 220 may be applied to the display apparatus 1 of FIG. 1 and the display panel 100 of FIG. 2.

The light source 210 includes a blue LED 211 that emits blue light, and an RG fluorescent body 212 that surrounds the blue LED 211 and is made of a phosphor material for emitting red and green light when colliding with blue light. A plurality of such light sources 210 is provided and used as the light source 51 (see FIG. 1).

Some of the blue light emitted from the blue LED 211 collides with particles of the RG fluorescent body 212. As the blue light collide with the particles of the RG fluorescent body 212, the red light or the green light comes out of the corresponding particles. Others of the blue light directly exit without colliding with the RG fluorescent body 212. Thus, the red light, the green light and the blue light are mixed and emitted from the light source 210 so that white light Lw can be finally emitted from the light source 210.

The reason why the light source 210 does not employ the LED for emitting the red or green light, but employs the blue LED 211 for emitting the blue light is as follows.

Since the wavelength of the blue light is shorter than those of the red light and the green light, the blue LED 211 for emitting the blue light has a higher optical efficiency with regard to an applied voltage than the LED for emitting the red light or the green light. In other words, the blue LED 211 can emit relatively much more light with regard to the same voltage.

Further, according to the low of energy conservation, energy moves from high to low, but cannot move from low to high. Therefore, an energy difference at collision between the blue light and phosphor particles generates the red light, but a collision between the red light and the phosphor particles cannot generate the blue light.

For this reason, the light source 210 employs the blue LED 211.

The white light Lw emitted from the light source 210 passes through the red dye layer 221, the green dye layer 222 and the blue dye layer 223 so that the red light Lr, the green light Lg and the blue light Lb can be emitted. Thus, RGB light exits from the color filter layer 220.

However, the color filter layer 220 basically has a filtering structure based on dye. Therefore, the red dye layer 221, the green dye layer 222 and the blue dye layer 223 cause an optical loss. For example, the red dye layer 221 transmits the red light Lr of the RGB light, but absorbs or blocks the green light Lg and the blue light Lb. Likewise, the green dye layer 222 transmits the green light Lg, but absorbs or blocks the red light Lr and the blue light Lb. Further, the blue dye layer 223 transmits the blue light Lb, but absorbs or blocks the red light Lr and the green light Lg.

In the color filter layer 220, only about 33% of the light Lw incident to the color filter layer 220 exits from the color filter layer 220, but the remaining 66% is absorbed or blocked by the color filter layer 220. Therefore, the structure in this exemplary embodiment has a great loss of the light Lw emitted from the light source 210.

To address this problem, an exemplary embodiment related to a structure for minimizing the loss of the light will be described below.

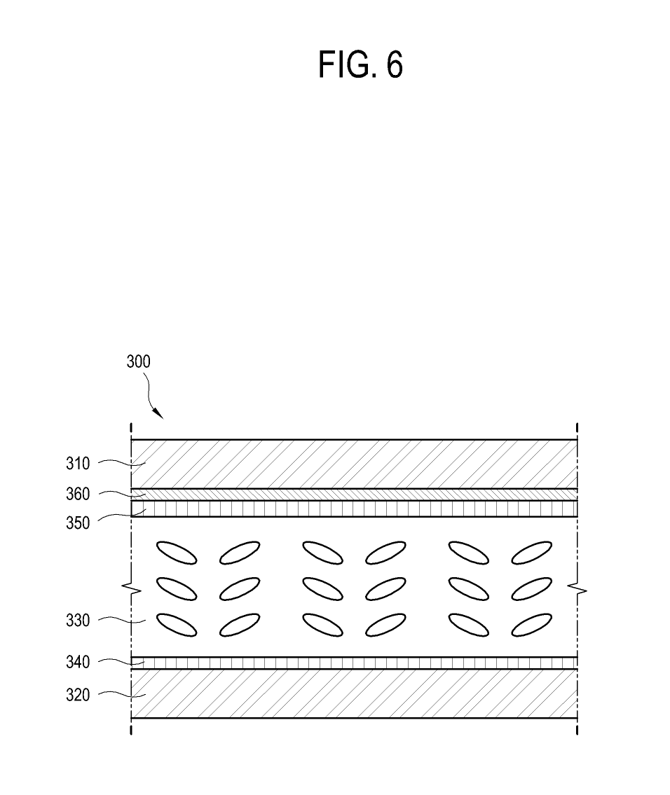

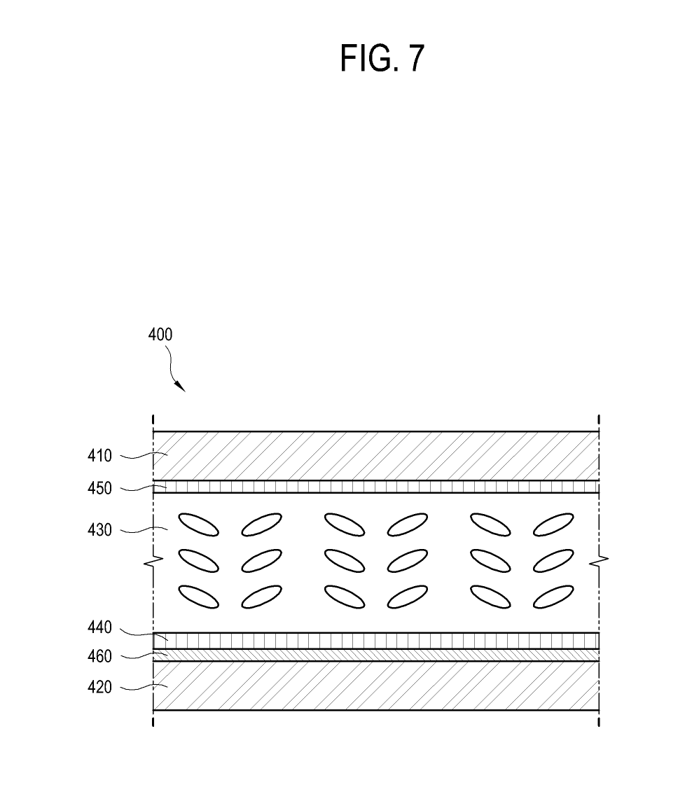

FIGS. 6 and 7 are cross-section views showing that elements of a display panel 300 are laminated according to an exemplary embodiment. The display panel 300 in this exemplary embodiment may also be applied to the display apparatus 1.

As shown in FIG. 6, the display panel 300 according to an exemplary embodiment includes an upper substrate 310, a lower substrate 320, a liquid crystal layer 330, a lower polarization layer 340, and an upper polarization layer 350. Such elements of the display panel 300 are substantially the same as those of the foregoing exemplary embodiment, and thus repetitive descriptions will be avoided as necessary.

The display panel 300 is interposed in between the upper substrate 310 and the upper polarization layer 350, and includes a color conversion layer 360 for converting the light polarized by the upper polarization layer 350.

Further, as shown in FIG. 7, a display panel 400 includes an upper substrate 410, a lower substrate 420, a liquid crystal layer 430, a lower polarization layer 440, and an upper polarization layer 450. These elements of the display panel 400 are the same as those of FIG. 6, and thus repetitive descriptions will be avoided as necessary.

The display panel 400 is interposed in between the lower substrate 420 and the lower polarization layer 440 and includes a color conversion layer 460 for converting color of light emitted from the backlight unit 50 (see FIG. 1).

The color conversion layer 460 of FIG. 7 and the color conversion layer 360 of FIG. 6 have the same function and structure, but different in the installed position. As shown in FIGS. 6 and 7, the color conversion layer 360, 460 is arranged outside the combination of the lower polarization layer 340, 440 and the upper polarization layer 350, 450, and not placed in between the lower polarization layer 340, 440 and the upper polarization layer 350, 450. This is because the color conversion layer 360, 460 is provided for converting the color of the light, detailed descriptions of which will be described later.

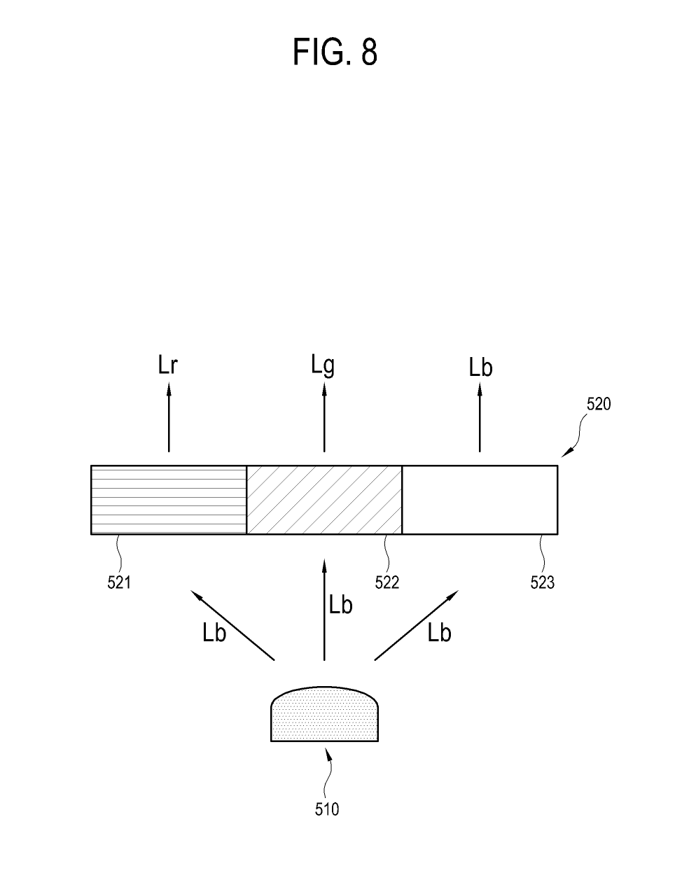

FIG. 8 shows an exemplary principle that a color conversion layer 520 that may be used in the display panel 300 of FIG. 6 and that filters RGB light from light Lb of a light source 510.

As shown in FIG. 8, the light source 510 includes a blue LED for generating and emitting blue light Lb. When compared to the light source in FIG. 1, the light source 510 in this exemplary embodiment directly emits the blue light Lb from the blue Led since it does not include the RG fluorescent body 212 (see FIG. 5).

Each pixel of the display panel 300, 400 includes an R-sub pixel, a G-sub pixel and a B-sub pixel corresponding to RGB colors. Thus, the color conversion layer 520 includes a red conversion layer 521 corresponding to the R-sub pixel and generating red light Lr based on collision with the blue light Lb, a green conversion layer 522 corresponding to the G-sub pixel and generating green light Lg based on collision with the blue light Lb, and a transmission layer 523 corresponding to the B-sub pixel and directly transmitting the blue light Lb.

The red conversion layer 521 and the green conversion layer 522 include a phosphor like the RG fluorescent body 212 of FIG. 5. The transmission layer 523 is made of a transparent material to directly transmit the blue light Lb. Of course, the phosphor of the red conversion layer 521 is different from that of the green conversion layer 522, and therefore the phosphor for the red conversion layer 521 generates the red light based on collision with the blue light and the phosphor for the green conversion layer 522 generates the green light based on collision with the blue light.

The light source 510 in this exemplary embodiment may be applied to the display apparatus 1 of FIG. 1, and the color conversion layer 520 in this exemplary embodiment may be applied to the display panels 300 and 400 of FIG. 6 and FIG. 7.

The blue light Lb from the light source 510 enters each of the red conversion layer 521, the green conversion layer 522 and the transmission layer 523. The red conversion layer 521 generates the red light Lr based on collision with the blue light Lb, and the green conversion layer 522 generates the green light Lg based on collision with the blue light Lb. The color filter layer 220 in FIG. 6 makes an optical loss since light of color unrelated to the corresponding sub pixel is absorbed. However, the red conversion layer 521 and the green conversion layer 522 in FIGS. 6 and 7 convert the color of the light based on the collision between the light and the phosphor, and therefore there is no optical loss or the optical loss is minimized. In addition, the transmission layer 523 directly transmits the blue light Lb without any conversion, and therefore no optical loss occurs.

Thus, the color conversion layer 520 can emit light with little loss or the minimum loss while converting the color of the light Lb emitted from the light source 510.

In this exemplary embodiment, the color conversion layer 520 includes the phosphor, but is not limited thereto. Alternatively, the color conversion layer 520 is not limited to the foregoing material or structure, and may be designed variously. For example, the color conversion layer 520 may include a quantum dot material.

Alternatively, the color conversion layer 520 may be achieved by the linear grid structure as shown in FIG. 3 and FIG. 4. For example, the red conversion layer 521 and the green conversion layer 522 may have the linear grid structures of which the pitch values correspond to the wavelengths of the red light and the green light, respectively.

The red conversion layer 521 and the green conversion layer 522 have to emit no blue light Lb so as to normally display colors of an image. However, the red conversion layer 521 and the green conversion layer 522 may emit a very small amount of blue light Lb due to a variety of unspecified causes such as design, material or the like problems. This means that the blue light Lb is emitted from the R-sub pixel and the G-sub pixel. Thus, colors of an image are abnormally displayed.

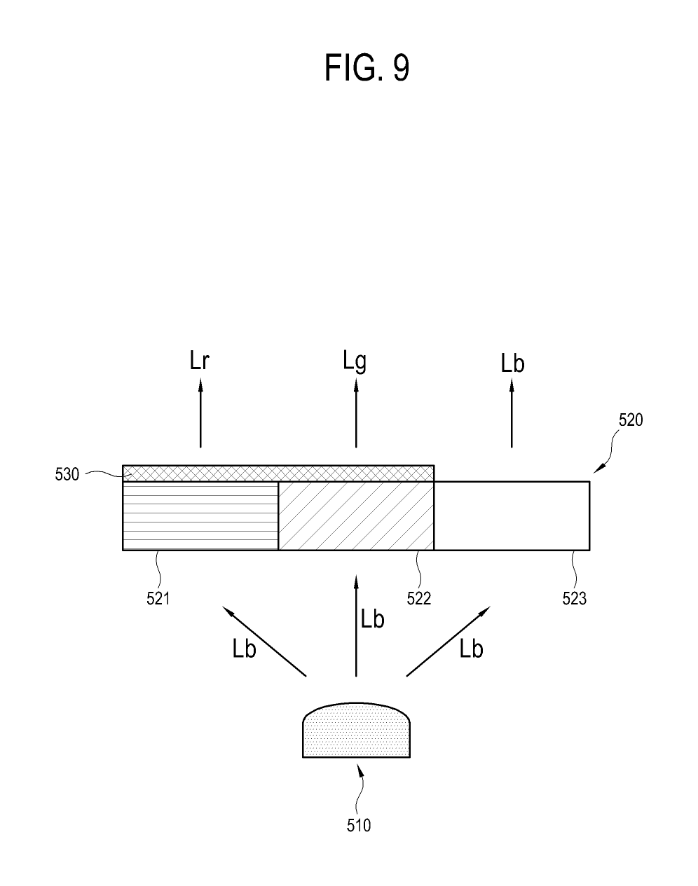

Below, an exemplary embodiment for addressing such problems will be described with reference to FIG. 9.

FIG. 9 shows a principle that a color conversion layer 520, according to an exemplary embodiment, filters RGB light from light Lb of a light source 510.

As shown in FIG. 9, the light source 510 includes a blue LED for generating and emitting blue light Lb, and the color conversion layer 520 includes a red conversion layer 521, a green conversion layer 522 and a transmission layer 523. Such configurations of the light source 510 and the color conversion layer 520 are substantially the same as those of FIG. 8, and thus repetitive descriptions thereof will be avoided.

According to this exemplary embodiment, the color conversion layer 520 includes a blue light filter layer 530 for covering light-exiting sides of the red conversion layer 521 and the green conversion layer 522 and blocking the blue light Lb. The blue light filter layer 530 does not cover the transmission layer 523 since the transmission layer 523 has to transmit the blue light Lb.

If the light emitted from the red conversion layer 521 and the green conversion layer 522 is mixed with the blue light Lb, the blue light filter layer 530 blocks such mixed blue light Lb and directly transmits the red light Lr and the green light Lg. Consequently, colors of an image are normally displayed since the R-sub pixel and the G-sub pixel emit no blue light Lb.

As described above with reference to FIG. 6 and FIG. 7, the color conversion layer 360 is interposed in between the upper substrate 310 and the upper polarization layer 350, or the color conversion layer 460 is interposed in between the lower substrate 420 and the lower polarization layer 440. That is, the color conversion layer 360, 460 is not interposed in between the upper polarization layer 350, 450 and the lower polarization layer 340, 440, but arranged outside the upper polarization layer 350, 450 and the lower polarization layer 340, 440.

The color conversion layer 360, 460 has a structure that the red light or the green light is emitted when the blue light collides with phosphor particles. In this case, the polarization properties of the light are changed. If the color conversion layer 360, 460 is interposed in between the upper polarization layer 350, 450 and the lower polarization layer 340, 440, the following situations occur. The light passes through the lower polarization layer 340, 440 enters the color conversion layer 360, 460 while having the polarization properties characterized by the lower polarization layer 340, 440. Since the polarization properties of the incident light are changed by the color conversion layer 360, 460, the light exiting from the color conversion layer 360, 460 may not pass through the upper polarization layer 350, 450.

Therefore, the color conversion layer 360, 460 has to be installed at a position before the light enters the upper polarization layer 350, 450 and the lower polarization layer 340, 440, or at a position after the light exits from the upper polarization layer 350, 450 and the lower polarization layer 340, 440.

For this reason, the color conversion layer 360, 460 according to these exemplary embodiments have to be applied to the display panel 300, 400 having the polarization layer structure of the linear grid. While the related art display panel has the structure that the film-type polarization layers are laminated outside the upper substrate and outside the lower substrate, the color conversion layer 360, 460 has to be structurally installed inside the display panel. If the color conversion layer 360, 460 is applied to the display panel having a related art polarization layer structure, there arises a problem that the color conversion layer is necessarily interposed in between the upper polarization layer and the lower polarization layer.

Accordingly, the color conversion layer 360, 460 in this exemplary embodiment is applied to the display panel 300, 400 including the upper polarization layer 350, 450 and the lower polarization layer 340, 440 having the linear grid structure, so that the color conversion layer 360, 460 can be arranged not only inside the display panel 300, 400 but also outside the upper polarization layer 350, 450 and the lower polarization layer 340, 440. Thus, the polarization properties of the light characterized by the upper polarization layer 350, 450 and the lower polarization layer 340, 440 are maintained and prevented from being affected by the color conversion layer 360, 460.

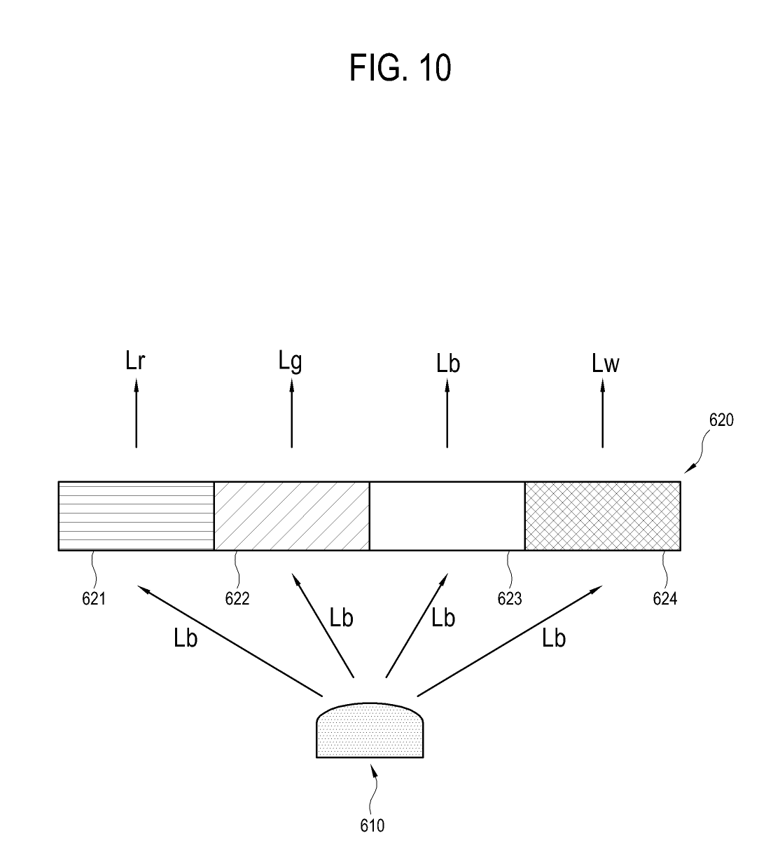

In the foregoing exemplary embodiment, the sub pixels of each pixel correspond to the sub pixels, but not limited thereto. In accordance with designs of the display panel, the sub pixels of each pixel may not correspond to the RGB colors. For example, the sub pixels of each pixel may correspond to red, green, blue and white (RGBW) colors. This exemplary embodiment will be described with reference to FIG. 10.

FIG. 10 shows a principle that a color conversion layer 620 according to an exemplary embodiment filters RGBW light from light Lb of a light source 610.

As shown in FIG. 10, the light source 610 includes a blue LED that emits blue light Lb. In this exemplary embodiment, the display panel includes four sub pixels per pixel corresponding to RGBW colors, respectively. That is, the color conversion layer 620 includes a red conversion layer 621 corresponding to an R-sub pixel and emitting a red light Lr, a green conversion layer 622 corresponding to a G-sub pixel and emitting green light Lg, a transmission layer 623 corresponding to a B-sub pixel and emitting the blue light Lb, and a white conversion layer 624 corresponding to a W-the sub pixel and emitting a white light Lw.

The red conversion layer 621, the green conversion layer 622 and the transmission layer 623 are substantially the same as those of the foregoing exemplary embodiments, and thus repetitive descriptions thereof will be avoided as necessary. The white conversion layer 624 generates the red light Lr and the green light Lg based on collision with a part of the blue light Lb, and then the red light Lr and the green light Lg are mixed with the remaining part of the blue light Lb, thereby finally generating white light Lw. The white conversion layer 624 includes a phosphor, and the phosphor may be achieved by mixing the phosphor of the red conversion layer 621 and the phosphor of the green conversion layer 622.

Thus, an exemplary embodiment may also be applied even though the sub pixels per pixel do not correspond to the RGB colors.

In addition, the blue light filter layer 530 described above with respect to FIG. 9 may be applied to this exemplary embodiment. In this case, the blue light filter layer is installed at the light-exiting sides of the red conversion layer 621, the green conversion layer 622 and the white conversion layer 624 in order to block the blue light Lb, but not installed at the light-exiting side of the transmission layer 623.

Here, the white light is generated by mixing of the red light, the green light and the blue light. Accordingly, the white light may not be output from the white conversion layer 624 if the blue light filter layer is installed at the light-exiting side of the white conversion layer 624. In this case, the blue light filter layer is installed at the light-exiting sides of the red conversion layer 621 and the green conversion layer 622, and is not installed at the light-exiting sides of the white conversion layer 624 and the transmission layer 623.

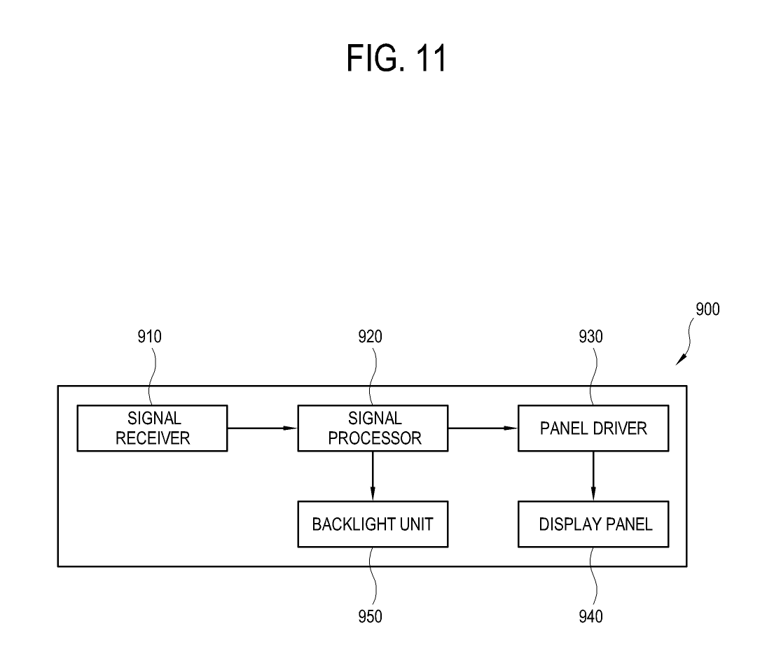

Below, a display apparatus 900 according to an exemplary embodiment will be described with reference to FIG. 11.

FIG. 11 is a block diagram of the display apparatus 900 according to an exemplary embodiment.

As shown in FIG. 11, the display apparatus 900 includes a signal receiver 910 for receiving an image signal, a signal processor 920 for processing the image signal received in the signal receiver 910 in accordance with preset image processing processes, a panel driver 930 for outputting a driving signal corresponding to the image signal processed by the signal processor 920, a display panel 940 for displaying an image based on the image signal in response to the driving signal from the panel driver 930, and a backlight unit 950 for emitting light to the display panel 940 in accordance with the image signal processed by the signal processor 920.

In this exemplary embodiment, the display apparatus 900 may be implemented as a television (TV), a monitor, a portable media player, a mobile phone, or the like device that can display an image.

The signal receiver 910 receives an image signal/image data and transmits it to the signal processor 920. The signal receiver 910 may be implemented in accordance with the standards of the image signal to be received and in accordance with the types of the display apparatus 900. For example, the signal receiver 910 may wirelessly receive a radio frequency (RF) signal transmitted from a broadcasting station (not shown), or may receive an image signal based on composite video, component video, super video, Syndicat des Constructeurs d'AppareilsRadiorécepteurs et Téléviseurs (SCART), high definition multimedia interface (HDMI), display port, unified display interface (UDI), or wireless HD standards. If the image signal is a broadcasting signal, the signal receiver 910 may include a tuner to be tuned to a channel corresponding to a broadcasting signal. Further, the signal receiver 910 may receive an image data packet from a server (not shown) through a network.

The signal processor 920 performs various image processing processes with regard to the image signal received in the signal receiver 910. The signal processor 920 outputs the processed image signal to the panel driver 930 so that an image based on the corresponding image signal can be displayed on the display panel 940.

There is no limit to the kind of image processing processes performed by the signal processor 920. For example, the image processing processes include decoding corresponding to an image format of image data, de-interlacing of converting interlaced image data into progressive image data, scaling of adjusting the image data to have a preset resolution, noise reduction for improving image quality, detail enhancement, frame refresh rate conversion, etc.

The signal processor 920 may be achieved by a system-on-chip where such various functions are merged, or by an image processing board (not shown) that individual elements capable of independently performing such processes are mounted to a printed circuit board, and then provided inside the display apparatus 900.

The panel driver 930, the display panel 940 and the backlight unit 950 are substantially the same as those of the foregoing exemplary embodiment, and thus repetitive descriptions of the panel driver 930, the display panel 940 and the backlight unit 950 will be avoided.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a light source configured to emit light corresponding to a first color among a plurality of preset colors; and
a display panel configured to display a color image with the light emitted from the light source,
the display panel comprising:
an upper substrate and a lower substrate;
a liquid crystal layer interposed in between the upper substrate and the lower substrate;
a lower polarization layer interposed in between the lower substrate and the liquid crystal layer, and configured to polarize the emitted light;
an upper polarization layer interposed in between the liquid crystal layer and the upper substrate, and configured to polarize the emitted light passed through the liquid crystal layer; and
a color conversion layer arranged in either at a first position between the upper substrate and the upper polarization layer or at a second position between the lower substrate and the lower polarization layer, and configured to emit light corresponding to the plurality of colors by converting a part of the light corresponding to the first color into light corresponding to respective colors other than the first color among the plurality of colors.

2. The display apparatus according to claim 1, wherein
the plurality of colors comprises red, green and blue (RGB) colors, and
wherein the first color comprises a blue color, and the colors other than the first color comprise red and green colors.

3. The display apparatus according to claim 2, wherein
the display panel comprises sub pixels per pixel, the sub pixels respectively corresponding to the RGB colors, and
wherein the color conversion layer comprises:
a red conversion layer comprising a first material including first particles which generate red light when the first particles collide with blue light, the red conversion layer configured to correspond to a red sub pixel; and
a green conversion layer comprising a second material including second particles which generate green light when the second particles collide with the blue light, the green conversion layer configured to correspond to a green sub pixel.

4. The display apparatus according to claim 3, wherein the first material of the red conversion layer and the second material of the green conversion layer comprise a phosphor or a quantum dot material.

5. The display apparatus according to claim 3, wherein the color conversion layer further comprises a transmission layer corresponding to a blue sub pixel, the transmission layer comprising a transparent material which directly transmits the blue light.

6. The display apparatus according to claim 3, further comprising a blue light filter layer arranged at light-exiting sides of the red conversion layer and the green conversion layer, and the blue light filter layer configured to block the blue light.

7. The display apparatus according to claim 3, wherein
the plurality of colors comprises a white (W) color in addition to the RGB colors, and
wherein the colors other than the first color comprise red, green and white colors.

8. The display apparatus according to claim 7, wherein
the sub pixels respectively correspond to the RGBW colors, and
wherein the color conversion layer further comprises a white conversion layer comprising a third material including third particles which generate white light when the third particles collide with the blue light, the white conversion layer configured to correspond to a white sub pixel.

9. The display apparatus according to claim 8, wherein the color conversion layer comprises a blue light filter layer arranged at light-exiting sides of the red conversion layer, the green conversion layer and the white conversion layer, the blue light filter configured to block the blue light.

10. The display apparatus according to claim 1, wherein at least one of the lower polarization layer and the upper polarization layer comprises a linear grid structure configured to polarize light in a preset polarization direction.

11. A display panel comprising:
an upper substrate and a lower substrate;
a liquid crystal layer interposed in between the upper substrate and the lower substrate;
a lower polarization layer interposed in between the lower substrate and the liquid crystal layer;
an upper polarization layer interposed in between the liquid crystal layer and the upper substrate; and
a color conversion layer arranged in either at a first position between the upper substrate and the upper polarization layer or at a second position between the lower substrate and the lower polarization layer.

12. The display apparatus according to claim 11, wherein the color conversion layer is configured to receive light corresponding to a first color and emit light corresponding to a plurality of colors by converting a part of the light corresponding to the first color into light corresponding to respective colors other than the first color among the plurality of colors.
